(19) United States
(12) Patent Application Publication
(10) Pub. No.: US 2015/0254043 A1
(43) Pub. Date: Sep. 10, 2015

(54) DISPLAY PROPERTY DETERMINATION

(71) Applicant: Sung Jae HWANG, Daejeon (KR)

(72) Inventor: Sung Jae HWANG, Daejeon (KR)

(21) Appl. No.: 14/455,007

(22) Filed: Aug. 8, 2014

(30) Foreign Application Priority Data
Mar. 4, 2014 (KR) 10-2014-0025580

(51) Int. Cl. G06F 3/14; H04N 13/04

(52) U.S. Cl. CPC G06F 3/1423; H04N 13/0484

(57) ABSTRACT

An electronic device may comprise two or more displays; a storage configured to store one or more contents to be displayed in a pseudo 3D visualization; an image generating unit configured to generate two or more images from one of the one or more contents stored in the storage; and an image displaying unit configured to respectively display each of the two or more images on each of the two or more displays to show the content in the pseudo 3D visualization.

### CROSS-REFERENCE TO RELATED PATENT APPLICATION

This application claims priority from the Korean Patent Application No. 10-2014-0025580, filed on Mar. 4, 2014 in the Korean Intellectual Property Office, the entire disclosure of which is incorporated herein by reference in its entirety.

### FIELD

Example embodiments broadly relate to schemes for displaying multiple images of a content on multiple display of an electronic device to show the content in a pseudo 3D visualization.

### BACKGROUND

There are various mechanisms for allowing a user to view multiple displays in effective ways. For example, in a public place, an electronic device having multiple displays is established to allow more users to view the same information concurrently.

### SUMMARY

According to an aspect of example embodiments, a method performed under control of an electronic device having two or more displays may comprise: retrieving, from a storage, a content to be displayed in a pseudo 3D visualization; generating two or more images from the content; and respectively displaying each of the two or more images on each of the two or more displays to show the content in the pseudo 3D visualization.

A first image of the two or more images may correspond to a front view of the content and the front view may be displayed on a first display of the two or more displays, and a second image of the two or more images may correspond to a rear view of the content and the rear view may be displayed on a second display of the two or more displays.

The method may further comprise modifying at least one of the two or more images when the electronic device is flipped; and displaying the at least one modified image on at least one of the two or more displays.

The modifying may comprise modifying a position and/or an appearance of at least one object of the two or more images based on a flipped direction of the electronic device.

The modifying the position and/or the appearance of the at least one object of the two or more images may comprise modifying both of the position and the appearance of the at least one object of the two or more images when the electronic device is in a first flip mode to provide a realistically physical view of the at least one object as the electronic device is flipped.

The modifying the position and/or the appearance of the at least one object of the two or more images may comprise modifying the appearance of the at least one object of the two or more images when the electronic device is in a second flip mode to provide a user friendly view of the at least one object by keeping the position of the at least one object unchanged as the electronic device is flipped.

The modifying may comprise modifying an arrangement order of objects of the two or more images based on a flipped direction of the electronic device.

The method may further comprise providing a user interface that allows a user to edit the at least one modified image.

The method may further comprise detecting an eye and/or a face of a user who faces one of the two or more displays; and modifying at least one of the two or more images based on the detected eye and/or the face.

The method may further comprise detecting an orientation of the electronic device; and modifying at least one of the two or more images based on the detected orientation.

According to another aspect of example embodiments, an electronic device may comprise two or more displays; a storage configured to store one or more contents to be displayed in a pseudo 3D visualization; an image generating unit configured to generate two or more images from one of the one or more contents stored in the storage; and an image displaying unit configured to respectively display each of the two or more images on each of the two or more displays to show the content in the pseudo 3D visualization.

The electronic device may further comprise image modifying unit configured to modify at least one of the two or more images when the electronic device is flipped and the image displaying unit may be further configured to display the at least one modified image on at least one of the tow or more displays.

The electronic device may further comprise a user interface unit configured to provide a user interface that allows a user to edit the at least one modified image.

The electronic device may further comprise detecting unit configured to detect an eye and/or a face of a user who faces one of the two or more displays; and the image modifying unit configured to modify at least one of the two or more images based on the detected eye and/or the face.

The electronic device may further comprise a detecting unit configured to detect an orientation of the electronic device; and an image modifying unit configured to modify at least one of the two or more images based on the detected orientation.

According to yet another aspect of example embodiments, a computer-readable storage medium having stored thereon computer-executable instructions that, in response to execution, may cause an electronic device to perform operations, comprising: retrieving, from a storage, a content to be displayed in a pseudo 3D visualization; generating two or more images from the content; respectively displaying each of the two or more images on each of two or more displays to show the content in the pseudo 3D visualization; and modifying at least one of the two or more images when the electronic device is flipped; and displaying the at least one modified image on at least one of the two or more displays.

### BRIEF DESCRIPTION OF THE DRAWINGS

Non-limiting and non-exhaustive example embodiments will be described in conjunction with the accompanying drawings. Understanding that these drawings depict only example embodiments and are, therefore, not intended to limit its scope, the example embodiments will be described with specificity and detail taken in conjunction with the accompanying drawings, in which:

FIG. 1 schematically shows an illustrative example of an interaction between a user and an electronic device having multiple displays in accordance with at least some embodiments described herein;

FIG. 2A schematically shows an illustrative example of two images displayed on displays of an electronic device in a physical flip mode in accordance with at least some embodiments described herein;

FIG. 2B schematically shows an illustrative example of two images displayed on displays of an electronic device in a cognitive flip mode in accordance with at least some embodiments described herein;

FIG. 3A schematically shows an illustrative example of an original image and modified images based on a flipped direction of an electronic device in a physical flip mode in accordance with at least some embodiments described herein;

FIG. 3B schematically shows an illustrative example of an original image and modified images based on a flipped direction of an electronic device in a cognitive flip mode in accordance with at least some embodiments described herein;

FIG. 4 schematically shows another illustrative example of two images displayed on displays of an electronic device in a physical flip mode in accordance with at least some embodiments described herein;

FIG. 5 schematically shows another illustrative example of two images displayed on displays of an electronic device in a cognitive flip mode in accordance with at least some embodiments described herein;

FIG. 6 schematically shows an illustrative example of various contents based on a flipped direction of an electronic device in accordance with at least some embodiments described herein.

FIG. 7 schematically shows another illustrative example of various contents based on a flipped direction of an electronic device in accordance with at least some embodiments described herein;

FIG. 8 shows a schematic block diagram illustrating an architecture for an electronic device in accordance with at least some embodiments described herein;

FIG. 9 shows an example processing flow for implementing multiple images on multiple displays of an electronic device described herein;

FIG. 10 shows another example processing flow for implementing multiple images on multiple displays of an electronic device described herein; and

FIG. 11 shows still another example processing flow for implementing multiple images on multiple displays of an electronic device described herein.

### DETAILED DESCRIPTION

Hereinafter, some embodiments will be described in detail. It is to be understood that the following description is given only for the purpose of illustration and is not to be taken in a limiting sense. The scope of the invention is not intended to be limited by the embodiments described hereinafter with reference to the accompanying drawings, but is intended to be limited only by the appended claims and equivalents thereof

It is also to be understood that in the following description of embodiments any direct connection or coupling between functional blocks, devices, components, circuit elements or other physical or functional units shown in the drawings or described herein could also be implemented by an indirect connection or coupling, i.e. a connection or coupling including one or more intervening elements. Furthermore, it should be appreciated that functional blocks or units shown in the drawings may be implemented as separate circuits in some embodiments, but may also be fully or partially implemented in a common circuit in other embodiments. In other words, the provision of functional blocks in the drawings is intended to give a clear understanding of the various functions performed, but is not to be construed as indicating that the corresponding functions are necessarily implemented in physically separate entities.

It is further to be understood that any connection which is described as being wire-based in the following specification may also be implemented as a wireless communication connection unless noted to the contrary.

The features of the various embodiments described herein may be combined with each other unless specifically noted otherwise. On the other hand, describing an embodiment with a plurality of features is not to be construed as indicating that all those features are necessary for practicing the present invention, as other embodiments may include less features and/or alternative features.

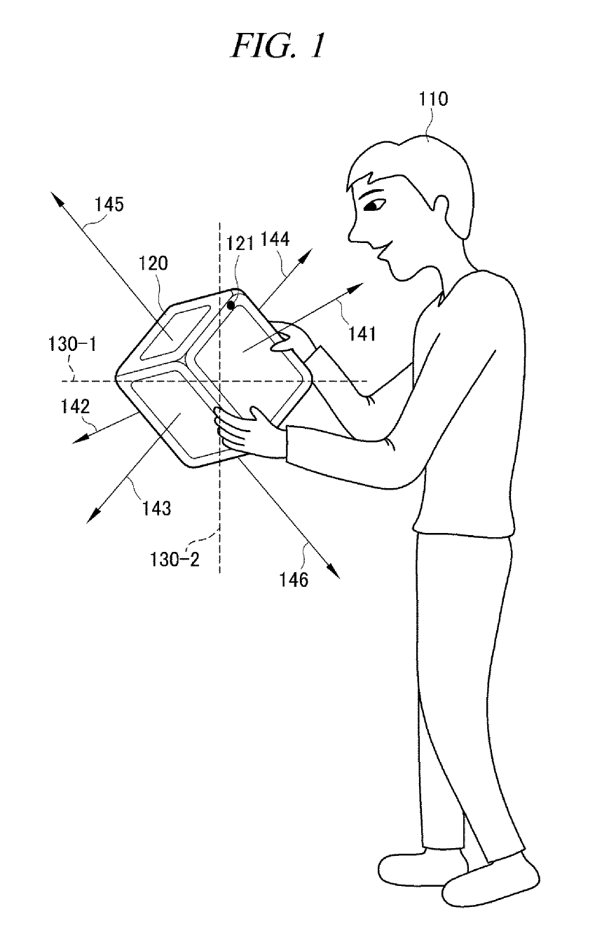

FIG. 1 schematically shows an illustrative example of an interaction between a user 110 and an electronic device 120 having multiple displays in accordance with at least some embodiments described herein. Although FIG. 1 illustrates that only one camera 121 and six displays are included in electronic device 120, one skilled in the art will appreciate that any number of cameras and displays can be included in electronic device 120 and moreover there can be any number of users who view the displays of electronic device 120.

As depicted in FIG. 1, electronic device 120 may include camera 121 and the six displays in the form of hexahedron. For example, six images can be generated from a content stored in a storage of electronic device 120 to be displayed in a pseudo 3D visualization, and displayed on the six displays of electronic device 120 respectively. For example, a front view of the content can be displayed on a first display in a direction 141, a rear view of the content can be displayed on a second display in a direction 142, a left side view of the content can be displayed on a third display in a direction 143, a right side view of the content can be displayed on a fourth display in a direction 144, a top view of the content can be displayed on a fifth display in a direction 145, and a bottom view of the content can be displayed on a sixth display in a direction 146.

In some embodiments, if camera 121 detects at least one of eyes or a face of user 110, then a first image, by way of example not limitation, the front view of the content may be displayed on the first display which faces user 110 in direction 141 and other images may be displayed other displays respectively. In some other embodiments, a sensor (not depicted) such as a gyroscope sensor included in electronic device 120 may detect an orientation of electronic device 120 by measuring tilting angles of the directions of the six displays 141, 142, 143, 144, 145 and 146 of electronic device 120 on the basis of base lines 130-1 and 130-2 to display the six images on the suitable displays of electronic device 120 respectively.

In some embodiments, on one hand, when the front view of the content has been presented to user in direction 141, if electronic device 120 is flipped in the opposite direction, the rear view of the content may be presented to user 110 in direction 141 instead of the front view while the front view of the content may be presented in direction 142, keeping the six images unchanged. On the other hand, if electronic device 120 is flipped in the opposite direction, the flipped direction of electronic device 120 may be detected by at least one of camera 121 or the sensor, and the six images may be modified based on the flipped direction of electronic device 120 accordingly. For example, the sensor such as the gyroscope sensor included in electronic device 120 may also detect the flipped direction of electronic device 120 by measuring the tilting angles of the directions of the six displays 141, 142, 143, 144, 145 and 146 as well as camera 121 may do the same by detecting the at least one of eyes or a face of user 110.

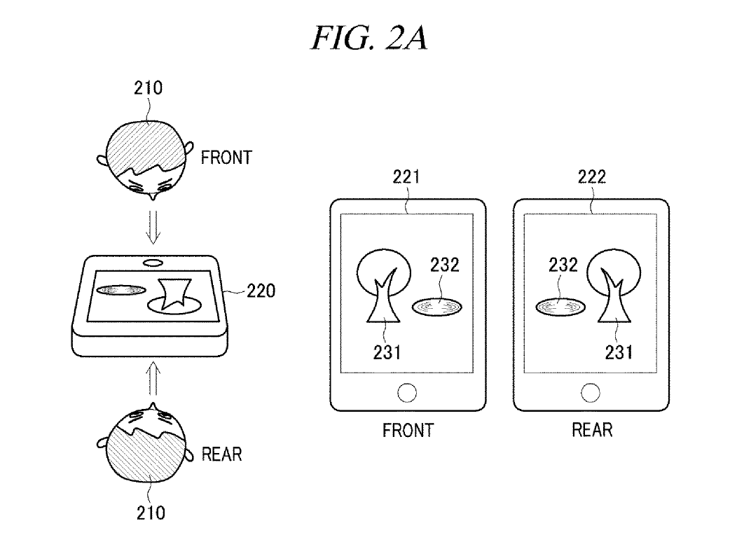

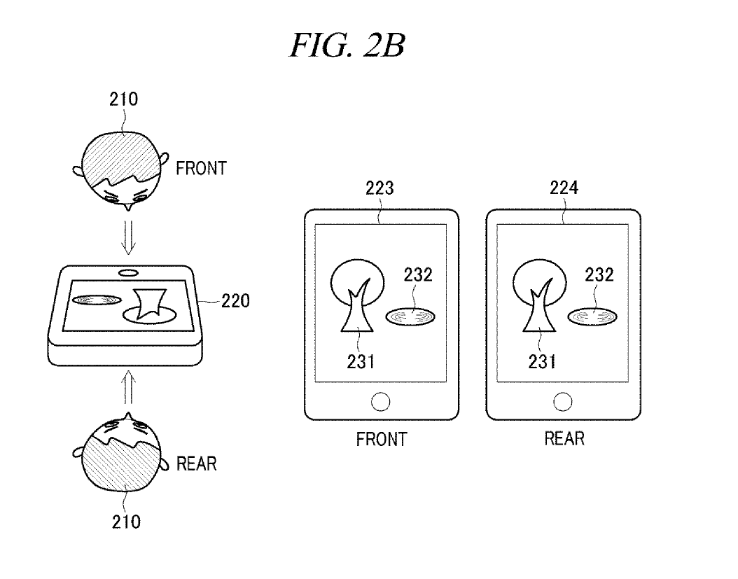

FIG. 2A schematically shows an illustrative example of two images 221 and 222 displayed on displays of an electronic device 220 in a physical flip mode in accordance with at least some embodiments described herein.

In some embodiments, image 221 of a front view of a content may be displayed when user 210 views one of the displays of electronic device 220 in front of electronic device 220 while image 222 of a rear view of the content may be displayed when user 210 views another of the displays of electronic device 220 at the back of electronic device 220. As presented in FIG. 2A, each of two images 221 and 222 may include two objects, a tree 231 and a pond 232. However, an appearance and a position of each tree 231 in two images 221 and 222 are different from each other and also an appearance and a position of each pond 232 in two images 221 and 222 are different from each other, that is, the appearances and the positions of tree 231 and pond 232 in two images 221 and 222 are reversed left-to-right. This provides a realistically physical view of the two objects in the physical flip mode.

In a scenario that user 210 looking at electronic device 220 flips electronic device 220, an appearance and a position of at least one object of an image to be presented to user 210 may be modified based on the flipped direction of electronic device 220. For example, in FIG. 2A, the image to be presented to user 210 may be modified from image 221 to image 222 as electronic device 220 is flipped from side to side.

FIG. 2B schematically shows an illustrative example of two images 223 and 224 displayed on displays of electronic device 220 in a cognitive flip mode in accordance with at least some embodiments described herein.

In some embodiments, image 223 of a front view of a content may be displayed when user 210 views one of the displays of electronic device 220 in front of electronic device 220 while image 224 of a rear view of the content may be displayed when user 210 views another of the displays of electronic device 220 at the back of electronic device 220. As presented in FIG. 2B, similarly to FIG. 2A, each of two images 223 and 224 includes two objects, tree 231 and pond 232. However, unlike FIG. 2A, the appearance and the position of each tree 231 in two images 223 and 224 are the same and also the appearance and the position of each pond 232 in two images 223 and 224 are the same, which provides a user friendly view of the two objects in the cognitive flip mode. Therefore, user 210 can view the same images of the same objects regardless of directions and positions of user 210.

In some embodiments, even if user 210 looking at electronic device 220 flips electronic device 220, an appearance and a position of at least one object of an image to be presented to user 210 may be kept unchanged as in FIG. 2B, that is, images 223 and 224 may be the same. In some embodiments, not the position but the appearance of the at least one object of the image to be presented to user 210 may be modified based on the flipped direction of electronic device 220. For example, in FIG. 2B, the appearance of each tree 231 and pond 232 may be reversed left-to-right as electronic device 220 is flipped from side to side.

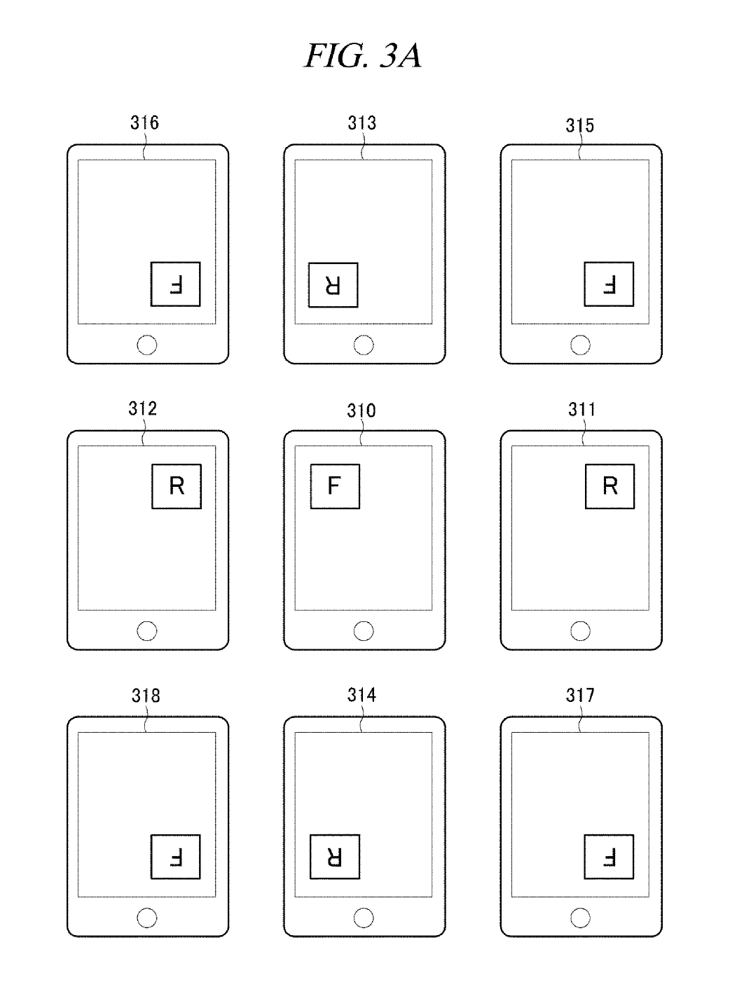

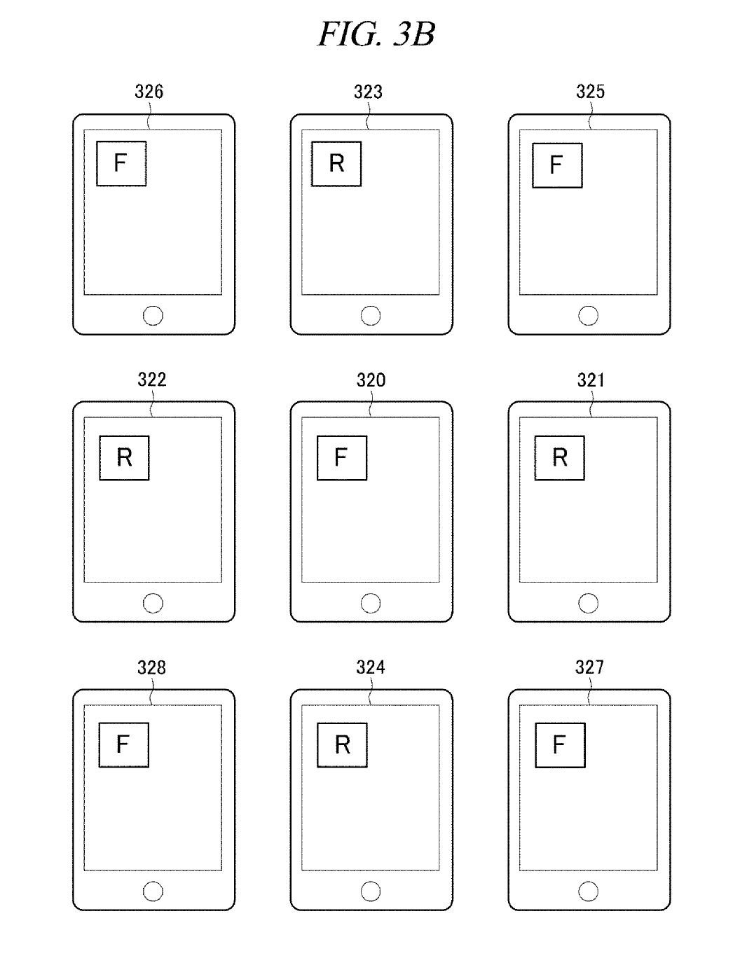

FIG. 3A schematically shows an illustrative example of an original image 310 and modified images 311-318 based on a flipped direction of an electronic device in a physical flip mode in accordance with at least some embodiments described herein. As mentioned above, in the physical flip mode, when the electronic device is flipped, a position and an appearance of at least one object of two or more images may be modified based on a flipped direction of the electronic device and the at least one modified image may be displayed on at least one of the two or more displays.

A content of original image 310 may include one object and a front view of the object is presented and placed at the top-left side in original image 310. Original image 310 may be displayed on one display which faces a user from among the two or more displays of the electronic device. When the electronic device is flipped, according to the flipped direction of the electronic device, an image to be presented to the user may be modified to one of images 311-318 on the basis of original image 310.

If the electronic device is flipped in a left-to-right direction, modified image 311 in which a rear view of the object generated from the content is placed at the top-right side may be displayed on the display which faces the user. If the electronic device is flipped in a right-to-left direction, modified image 312 which has the same characteristics as modified image 311 may be displayed. If the electronic device is flipped in a bottom-to-top direction or a top-to-bottom direction, modified image 313 or 314 in which the rear view of the object included in the content is presented as reversed and placed at the bottom-left side may be displayed on the display facing the user. Further, if the electronic device is flipped twice, modified image 315, 316, 317 or 318 may be displayed. For example, if the electronic device is flipped the left-to-right direction once and then the bottom-to-top direction once, modified image 315 in which the front view of the object included in the content is presented as reversed and placed at the bottom-right side may be displayed on the display facing the user.

FIG. 3B schematically shows an illustrative example of an original image 320 and modified images 321-328 based on a flipped direction of an electronic device in a cognitive flip mode in accordance with at least some embodiments described herein. As mentioned above, in the cognitive flip mode, when the electronic device is flipped, an appearance of at least one object of two or more images may be modified based on a flipped direction of the electronic device, while a position of the at least one object may be fixed. Then, the at least one modified image may be displayed on at least one of the two or more displays.

A content of original image 320 may include one object and a front view of the object is presented and placed at the top-left side in original image 320. Original image 320 may be displayed on one display which faces a user from among the two or more displays of the electronic device. When the electronic device is flipped, according to the flipped direction of the electronic device, an image to be presented to the user may be modified to one of images 321-328 on the basis of original image 320.

If the electronic device is flipped in a left-to-right direction, modified image 321 in which a rear view of the object included in the content is placed at the top-left side may be displayed on the display with faces the user. If the electronic device is flipped in a right-to-left direction, modified image 322 which has the same characteristics as modified images 321 may be displayed. If the electronic device is flipped in a bottom-to-top direction or a top-to-bottom direction, modified image 323 or 324 in which the rear view of the object included in the content is placed at the top-left side may be displayed on the display which faces the user. Also, if the electronic device is flipped twice, modified image 325, 326, 327 or 328 may be displayed. For example, if the electronic device is flipped the left-to-right direction once and then the bottom-to-top direction once, modified image 325 in which the front view of the object included in the content is placed at the top-left side may be displayed on the display which faces the user.

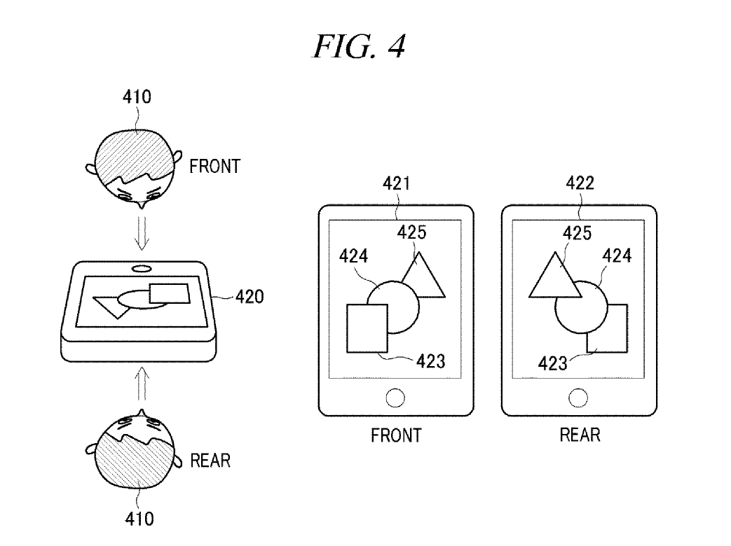

FIG. 4 schematically shows another illustrative example of two images 421 and 422 displayed on displays of an electronic device 420 in a physical flip mode in accordance with at least some embodiments described herein.

In some embodiments, image 421 of a front view of a content may be displayed when user 410 views one of the displays of electronic device 420 in front of electronic device 420 while image 422 of a rear view of the content may be displayed when user 410 views another of the displays of electronic device 420 at the back of electronic device 420. As presented in FIG. 4, each of two images 421 and 422 includes three objects, a square 423, a circle 424 and a triangle 425 and the three objects stand in order, generating an occlusion. Specifically, in image 421, circle 424 occludes triangle 425 and square 423 occludes circle 424 partly, while in image 422, circle 424 occludes square 423 and triangle 425 occludes circle 424 partly. The appearances, the positions and the arrangement order of three objects in two images 421 and 422 are reversed compared with each other to provide a realistically physical view of the three objects to show the content in a pseudo 3D visualization. Therefore, user 410 can experience to see the real configuration from the different views.

In a scenario that user 410 looking at electronic device 420 flips electronic device 420, an appearance, a position and an arrangement order of at least one object of an image to be presented to user 410 may be modified based on the flipped direction of electronic device 420. For example, the image to be presented to user 410 may be modified from image 421 to image 422 as electronic device 420 is flipped from side to side.

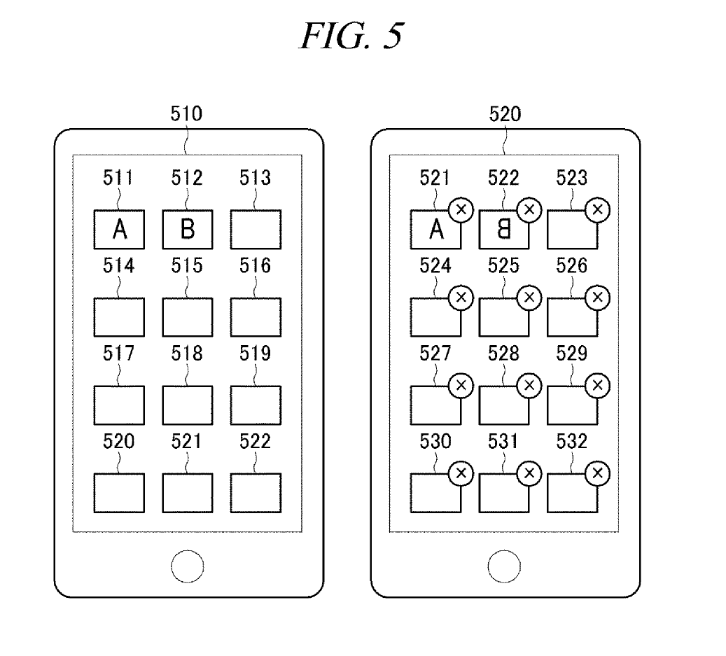

FIG. 5 schematically shows another illustrative example of two images 510 and 520 displayed on displays of an electronic device in a cognitive flip mode in accordance with at least some embodiments described herein. In some embodiments, a content of image 510 may include a plurality of objects 511-522 and front views of the plurality of objects 511-522 are presented in image 510. By way of example, but not limitation, image 510 may be displayed on one display facing the user from among two or more displays of the electronic device. When the electronic device is flipped, according to the flipped direction of the electronic device, image 520 modified on the basis of image 510 may be displayed on the display facing the user. As depicted in FIG. 5, if the electronic device is flipped from side to side, for example, appearances of objects 511 and 512 may be presented as reversed left-to-right but positions of objects 511 and 512 may not be changed. Furthermore, as the electronic device is flipped from side to side, the user interface may be provided to allow the user to remove any of the plurality of objects 511-522 in modified image 520 which may be application icons such that the user can remove at least one corresponding application.

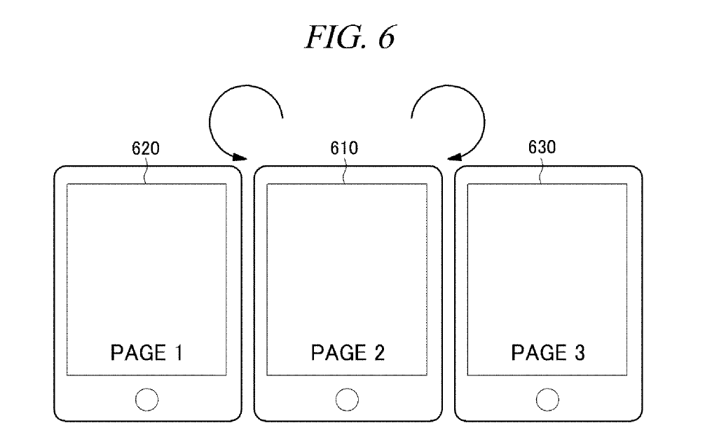

FIG. 6 schematically shows an illustrative example of various contents 610, 620 and 630 based on a flipped direction of an electronic device in accordance with at least some embodiments described herein. In some embodiments, when the electronic device is flipped, according to the flipped direction of the electronic device, various contents can be presented. For example, in cases where a user reads an electronic book using an associated application of the electronic device, depending on the flipped direction, the user can return to the previous page or turn to the next page of the electronic book. As depicted in FIG. 6, when the user is reading the page 2 of an image 610, if the user flips the electronic device in a left-to-right direction, an image 630 associated with the next page 3 may be presented on a display which faces the user and if the user flips the electronic device in a right-to-left direction, an image 620 associated with the previous page 1 may be presented on the display which faces the user.

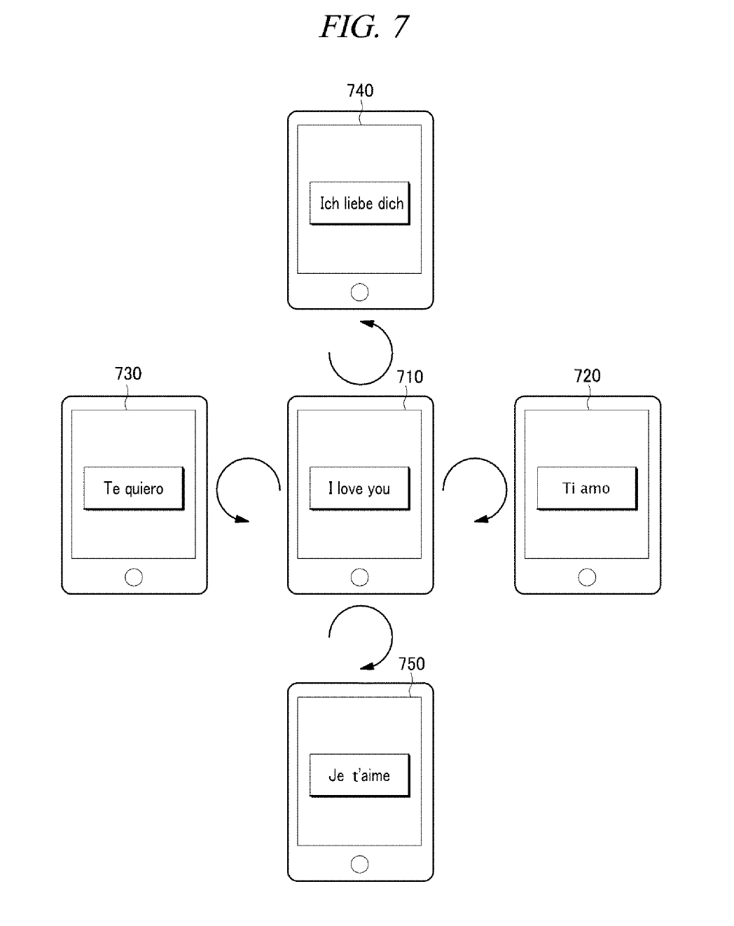

FIG. 7 schematically shows another illustrative example of various contents based on a flipped direction of an electronic device in accordance with at least some embodiments described herein. When the electronic device is flipped, according to the flipped direction of the electronic device, various contents can be presented. For example, in cases where a user makes use of any of language translation application of the electronic device, depending on the flipped direction, the user can see the translated words in various languages. As depicted in FIG. 7, “I love you” is presented in English in an image 710. If the user flips the electronic device in a left-to-right direction, Italian words “Ti amo” translated from the English words may be presented in an image 720; if the user flips the electronic device in a right-to-left direction, Spanish words “Te quiero” translated from the English words may be presented in an image 730; if the user flips the electronic device in a bottom-to-top direction, German words “Ich liebe dich” translated from the English words may be presented in an image 740; and if the user flips the electronic device in a top-to-bottom direction, French words “Je t'aime” translated from the English words may be presented in an image 750.

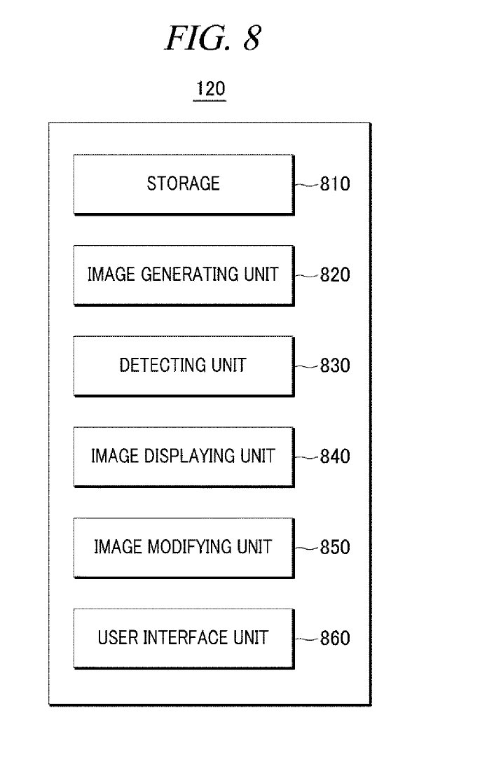

FIG. 8 shows a schematic block diagram illustrating an architecture for electronic device 120 in accordance with at least some embodiments described herein. Electronic device 120 may include a storage 810, an image generating unit 820, a detecting unit 830, an image displaying unit 840, an image modifying unit 850, a user interface unit 860, and also two or more displays (not depicted). It will be understood by those skilled in the art that each function and/or operation of the components may be implemented, individually and/or collectively, by a wide range of hardware, software, firmware, or virtually any combination thereof.

Storage 810 may be configured to store one or more contents to be displayed in the pseudo 3D visualization. In some embodiments, storage 810 may be further configured to store two or more images generated from the one or more contents and/or at least one modified image.

Image generating unit 820 may be configured to generate two or more images from one of the one or more contents in storage 810. By way of example, image generating unit 820 may be configured to generate the images as many as the number of the two or more displays of electronic device 120.

Detecting unit 830 may be configured to detect a viewpoint of a user. In some embodiments, detecting unit 830 may be configured to allow a camera (not depicted) of electronic device 120 to detect at least one of eyes or a face of the user. In some other embodiments, detecting unit 830 may be configured to allow a sensor (not depicted) of electronic device 120 such as a gyroscope sensor to detect an orientation of the electronic device by measuring tilting angles of directions of the two or more displays of electronic device 120 on the basis of base lines.

In some embodiments, detecting unit 830 may be configured to detect that electronic device 120 is flipped. In some embodiments, detecting unit 830 may be configured to allow the sensor of electronic device 120 to detect the flipped direction of electronic device 120 by measuring the tilting angles of the directions of the two or more displays. In some other embodiments, detecting unit 830 may be configured to allow the camera of electronic device 120 to detect the flipped direction of electronic device 120 by detecting the at least one of eyes or a face of the user.

Image displaying unit 840 may be configured to display each of the two or more generated images on each of the two or more displays of electronic device 120 respectively, based on the detected viewpoint of the user. In some embodiments, image displaying unit 840 may be further configured to display the at least one modified image on at least one of the two or more displays.

Image modifying unit 850 may be configured to modify an appearance and/or a position of at least one object, and/or an arrangement order of objects of at least one of the two or more images according to whether electronic device 120 is in a physical flip mode or a cognitive flip mode. In some embodiments, when electronic device 120 is in the physical flip mode, image modifying 850 may be configured to modify both of the position and the appearance of the at least one object of the two or more images based on the flipped direction of electronic device 120 to provide the user with the real configurations from the different views. In some embodiments, if the objects occlude each other and thereby the occlusion is generated, image modifying unit 850 may be further configured to modify the arrangement order of the objects, based on the flipped direction of electronic device 120.

In some embodiments, when electronic device 120 is in the cognitive flip mode, image modifying unit 850 may be configured to modify the appearance of the at least one object of the two or more images based on the flipped direction of electronic device 120 to provide the user with the friendly views.

User interface unit 860 may be configured to provide a user interface that allows the user to edit the at least one modified image. In some embodiments, user interface unit 860 may be configured to provide the user interface that allows the user to remove any one of the at least one object in the at least one modified image.

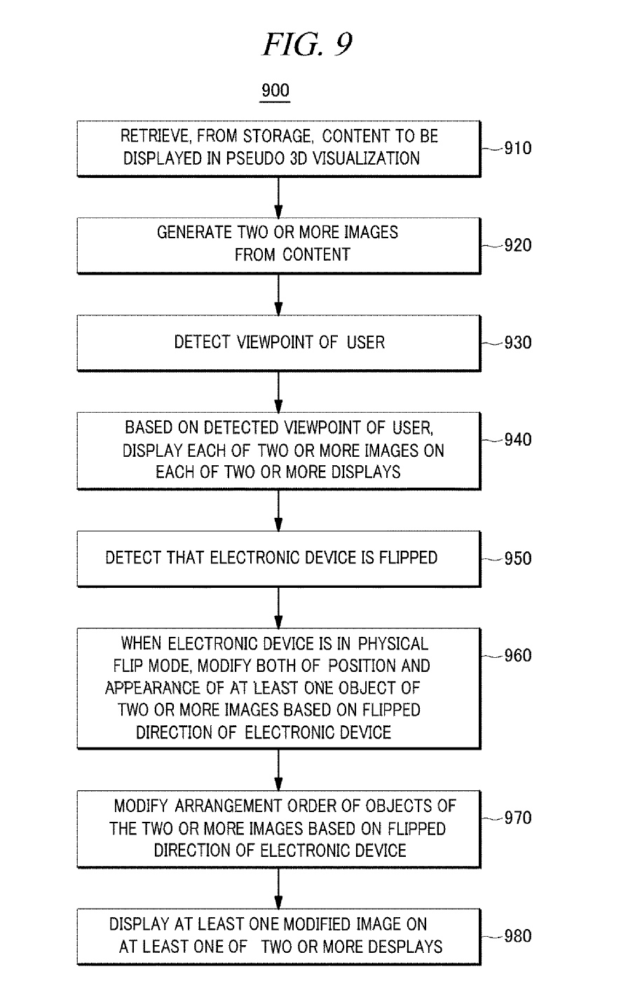

FIG. 9 shows an example processing flow for implementing multiple images on multiple displays of an electronic device described herein. The process in FIG. 9 may be implemented by electronic device 120 including storage 810, image generating unit 820, detecting unit 830, image displaying unit 840, image modifying unit 850 and user interface unit 860, as described above. An example process may include one or more operations, actions, or functions as illustrated by one or more blocks 910, 920, 930, 940, 950, 960, 970 and/or 980. Although illustrated as discrete blocks, various blocks may be divided into additional blocks, combined into fewer blocks, or eliminated, depending on the desired implementation. Processing may begin at block 910.

At block 910 (Retrieve, from a Storage, a Content to be Displayed in a Pseudo 3D Visualization), an electronic device may retrieve, from a storage, a content to be displayed in a pseudo 3D visualization. Processing may continue from block 910 to block 920.

At block 920 (Generate two or more Images from the Content), the electronic device may generate two or more images from the content. By way of example, the electronic device may generate the images as many as the number of two or more displays of the electronic device. Processing may proceed from block 920 to block 930.

At block 930 (Detect a Viewpoint of a User), the electronic device may detect a viewpoint of a user. In some embodiments, a camera of the electronic device may detect at least one of eyes or a face of the user. In some other embodiments, a sensor of the electronic device such as a gyroscope sensor may detect an orientation of the electronic device by measuring tilting angles of directions of the two or more displays of the electronic device on the basis of base lines. Processing may proceed from block 930 to block 940.

At block 940 (Based on the Detected Viewpoint of the User, Display each of the two or more Images on each of two or more Displays), based on the detected viewpoint of the user, the electronic device may display each of the two or more images on each of the two or more displays. In some embodiments, the electronic device may display the front view of the content on a first display which faces the user and other images on other displays respectively. Processing may proceed from block 940 to block 950.

At block 950 (Detect that an Electronic Device is Flipped), the electronic device may detect that the electronic device is flipped. In some embodiments, as mentioned above, the sensor such as the gyroscope sensor of the electronic device may also detect the flipped direction of the electronic device by measuring the tilting angles of directions of the two or more displays as well as the camera may do the same by detecting the at least one of eyes or a face of the user. Processing may proceed from block 950 to block 960.

At block 960 (When the Electronic Device is in a Physical Flip Mode, Modify Both of a Position and an Appearance of at least one Object of the two or more Images Based on a Flipped Direction of the Electronic Device), when the electronic device is in a physical flip mode, the electronic device may modify both of a position and an appearance of the at least one object of the two or more images based on a flipped direction of the electronic device. In some embodiments, if the electronic device is flipped from side to side, the electronic device may modify the position and the appearance of the at least one object to be reversed left-to-right. Processing may proceed from block 960 to block 970.

At block 970 (Modify an Arrangement order of Objects of the two or more Images Based on the Flipped Direction of the Electronic Device), the electronic device may modify an arrangement order of objects of the two or more images based on the flipped direction of the electronic device. In some embodiments, if the objects occlude each other and thereby the occlusion is generated, the electronic device may also modify the arrangement order of the objects as well as the position and the appearance of the at least one object, based on the flipped direction of the electronic device. Processing may proceed from block 970 to block 980.

At block 980 (Display at least one Modified Image on at least one of the two or more Displays), the electronic device may display at least one modified image on at least one of the two or more displays.

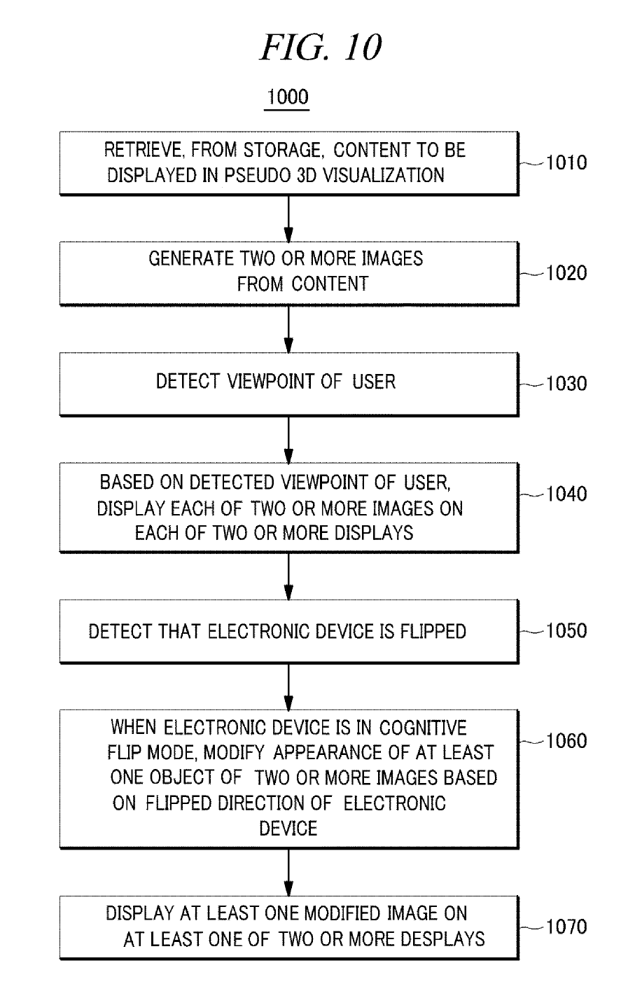

FIG. 10 shows another example processing flow for implementing multiple images on multiple displays of an electronic device described herein. The process in FIG. 10 may be implemented by electronic device 120 including storage 810, image generating unit 820, detecting unit 830, image displaying unit 840, image modifying unit 850 and user interface unit 860, as described above. An example process may include one or more operations, actions, or functions as illustrated by one or more blocks 1010, 1020, 1030, 1040, 1050, 1060 and/or 1070. Although illustrated as discrete blocks, various blocks may be divided into additional blocks, combined into fewer blocks, or eliminated, depending on the desired implementation. Processing may begin at block 1010.

At block 1010 (Retrieve, from a Storage, a Content to be Displayed in a Pseudo 3D Visualization), an electronic device may retrieve, from a storage, a content to be displayed in a pseudo 3D visualization. Processing may continue from block 1010 to block 1020.

At block 1020 (Generate two or more Images from the Content), the electronic device may generate two or more images from the content. By way of example, the electronic device may generate the images as many as the number of two or more displays of the electronic device. Processing may proceed from block 1020 to block 1030.

At block 1030 (Detect a Viewpoint of a User), the electronic device may detect a viewpoint of a user. In some embodiments, a camera of the electronic device may detect at least one of eyes or a face of the user. In some other embodiments, a sensor of the electronic device such as a gyroscope sensor may detect an orientation of the electronic device by measuring tilting angles of directions of the two or more displays of the electronic device on the basis of base lines. Processing may proceed from block 1030 to block 1040.

At block 1040 (Based on the Detected Viewpoint of the User, Display each of the two or more Images on each of two or more Displays), based on the detected viewpoint of the user, the electronic device may display each of the two or more images on each of the two or more displays. In some embodiments, the electronic device may display the front view of the content on a first display which faces the user and other images on other displays respectively. Processing may proceed from block 1040 to block 1050.

At block 1050 (Detect that an Electronic Device is Flipped), the electronic device may detect that the electronic device is flipped. In some embodiments, as mentioned above, the sensor such as the gyroscope sensor of the electronic device may also detect the flipped direction of the electronic device by measuring the tilting angles of directions of the two or more displays as well as the camera may do the same by detecting the at least one of eyes or a face of the user. Processing may proceed from block 1050 to block 1060.

At block 1060 (When the Electronic Device is in a Cognitive Flip Mode, Modify Both of an Appearance of at least one Object of the two or more Images Based on a Flipped Direction of the Electronic Device), when the electronic device is in a cognitive flip mode, the electronic device may modify a appearance of the at least one object of the two or more images based on a flipped direction of the electronic device. In some embodiments, if the electronic device is flipped from side to side, the electronic device may modify the appearance of the at least one object to be reversed left-to-right. Processing may proceed from block 1060 to block 1070.

At block 1070 (Display at least one Modified Image on at least one of the two or more Displays), the electronic device may display at least one modified image on at least one of the two or more displays.

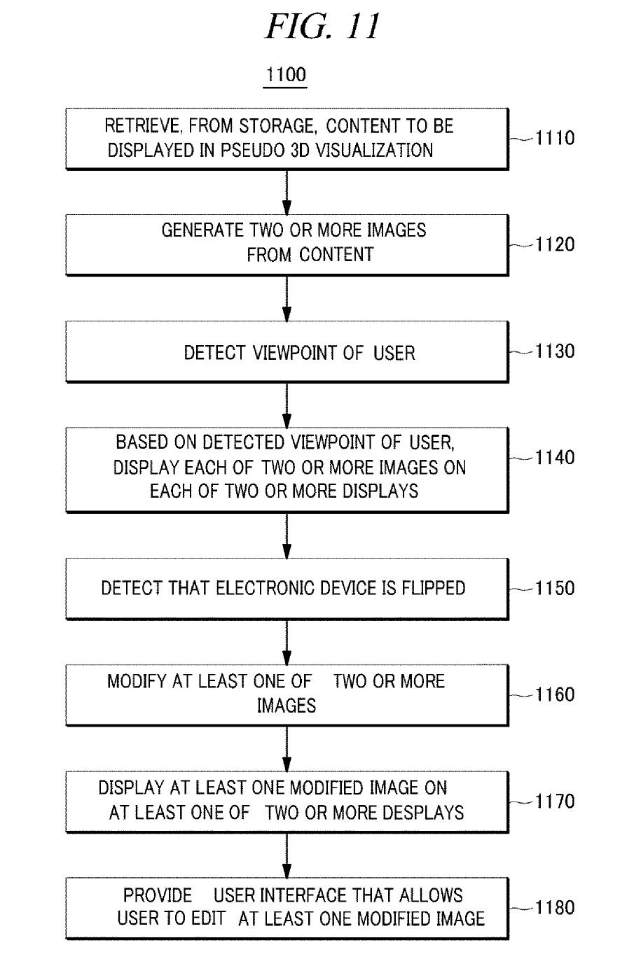

FIG. 11 shows still another example processing flow for implementing multiple images on multiple displays of an electronic device described herein. The process in FIG. 11 may be implemented by electronic device 120 including storage 810, image generating unit 820, detecting unit 830, image displaying unit 840, image modifying unit 850 and user interface unit 860, as described above. An example process may include one or more operations, actions, or functions as illustrated by one or more blocks 1110, 1120, 1130, 1140, 1150, 1160, 1170 and/or 1180. Although illustrated as discrete blocks, various blocks may be divided into additional blocks, combined into fewer blocks, or eliminated, depending on the desired implementation. Processing may begin at block 1110.

At block 1110 (Retrieve, from a Storage, a Content to be Displayed in a Pseudo 3D Visualization), an electronic device may retrieve, from a storage, a content to be displayed in a pseudo 3D visualization. Processing may continue from block 1110 to block 1120.

At block 1120 (Generate two or more Images from the Content), the electronic device may generate two or more images from the content. By way of example, the electronic device may generate the images as many as the number of two or more displays of the electronic device. Processing may proceed from block 1120 to block 1130.

At block 1130 (Detect a Viewpoint of a User), the electronic device may detect a viewpoint of a user. In some embodiments, a camera of the electronic device may detect at least one of eyes or a face of the user. In some other embodiments, a sensor of the electronic device such as a gyroscope sensor may detect an orientation of the electronic device by measuring tilting angles of directions of the two or more displays of the electronic device on the basis of base lines. Processing may proceed from block 1130 to block 1140.

At block 1140 (Based on the Detected Viewpoint of the User, Display each of the two or more Images on each of two or more Displays), based on the detected viewpoint of the user, the electronic device may display each of the two or more images on each of the two or more displays. In some embodiments, the electronic device may display the front view of the content on a first display which faces the user and other images on other displays respectively. Processing may proceed from block 1140 to block 1150.

At block 1150 (Detect that an Electronic Device is Flipped), the electronic device may detect that the electronic device is flipped. In some embodiments, as mentioned above, the sensor such as the gyroscope sensor of the electronic device may also detect the flipped direction of the electronic device by measuring the tilting angles of directions of the two or more displays as well as the camera may do the same by detecting the at least one of eyes or a face of the user. Processing may proceed from block 1150 to block 1160.

At block 1160 (Modify at least one of the two or more Images), the electronic device may modify at least one of the two or more images. In some embodiments, according to whether the electronic device is in a physical flip mode or a cognitive flip mode, the electronic device may modify an appearance and/or a position of at least one object, and/or an arrangement order of objects of the at least one of the two or more images. Processing may proceed from block 1160 to block 1170.

At block 1170 (Display the at least one Modified Image on at least one of the two or more Displays), the electronic device may display the at least one modified image on at least one of the two or more displays. Processing may proceed from block 1170 to block 1180.

At block 1180 (Provide a User Interface that Allows the User to Edit the at least one Modified Image), the electronic device may provide a user interface that allows the user to edit the at least one modified image. In some embodiments, the electronic device may provide the user interface that allows the user to remove any one of at least one object in the at least one modified image.

The examples described above, with regard to FIGS. 1-11, may be implemented in a computing environment having components that include, but are not limited to, one or more processors, system memory, and a system bus that couples various system components. Further, the computing environment may include a variety of computer readable media that are accessible by any of the various components, and includes both volatile and non-volatile media, removable and non-removable media.

Various modules and techniques may be described herein in the general context of computer-executable instructions, such as program modules, executed by one or more computers or other devices. Generally, program modules include routines, programs, objects, components, data structures, etc. for performing particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, but not limitation, computer readable media may include computer storage media and communications media.

Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Communication media typically embodies computer readable instructions, data structures, program modules, or other data in a modulated data signal, such as carrier wave or other transport mechanism. Communication media also includes any information delivery media. The term modulated data signal means a signal that has one or more of its characteristics set or changed in such a manner as to encode information in the signal. As a non-limiting example only, communication media includes wired media such as a wired network or direct-wired connection, and wireless media such as acoustic, RF, infrared, and other wireless media. Combinations of any of the above are also included within the scope of computer readable media.

Reference has been made throughout this specification to “one embodiment,” “an embodiment,” or “an example embodiment” meaning that a particular described feature, structure, or characteristic is included in at least one embodiment of the present invention. Thus, usage of such phrases may refer to more than just one embodiment. Furthermore, the described features, structures, or characteristics may be combined in any suitable manner in one or more embodiments.

While example embodiments and applications of the present invention have been illustrated and described, it is to be understood that the invention is not limited to the precise configuration and resources described above. Various modifications, changes, and variations apparent to those skilled in the art may be made in the arrangement, operation, and details of the methods and systems of the present invention disclosed herein without departing from the scope of the claimed invention.

One skilled in the relevant art may recognize, however, that the invention may be practiced without one or more of the specific details, or with other methods, resources, materials, etc. In other instances, well known structures, resources, or operations have not been shown or described in detail merely to avoid obscuring aspects of the invention.

What is claimed is:

1. A method performed under control of an electronic device having two or more displays, comprising:
retrieving, from a storage, a content to be displayed in a pseudo 3D visualization;
generating two or more images from the content; and
respectively displaying each of the two or more images on each of the two or more displays to show the content in the pseudo 3D visualization.

2. The method of claim 1, wherein a first image of the two or more images corresponds to a front view of the content and the front view is displayed on a first display of the two or more displays, and
a second image of the two or more images corresponds to a rear view of the content and the rear view is displayed on a second display of the two or more displays.

3. The method of claim 1, further comprising:
modifying at least one of the two or more images when the electronic device is flipped; and
displaying the at least one modified image on at least one of the two or more displays.

4. The method of claim 3, wherein the modifying comprises:
modifying a position and/or an appearance of at least one object of the two or more images based on a flipped direction of the electronic device.

5. The method of claim 4, wherein the modifying the position and/or the appearance of the at least one object of the two or more images comprises:
modifying both of the position and the appearance of the at least one object of the two or more images when the electronic device is in a first flip mode to provide a realistically physical view of the at least one object as the electronic device is flipped.

6. The method of claim 4, wherein the modifying the position and/or the appearance of the at least one object of the two or more images comprises:
modifying the appearance of the at least one object of the two or more images when the electronic device is in a second flip mode to provide a user friendly view of the at least one object by keeping the position of the at least one object unchanged as the electronic device is flipped.

7. The method of claim 3, wherein the modifying comprises:
modifying an arrangement order of objects of the two or more images based on a flipped direction of the electronic device.

8. The method of claim 3, further comprising:
providing a user interface that allows a user to edit the at least one modified image.

9. The method of claim 1, further comprising:
detecting an eye and/or a face of a user who faces one of the two or more displays; and
modifying at least one of the two or more images based on the detected eye and/or the face.

10. The method of claim 1, further comprising:
detecting an orientation of the electronic device; and
modifying at least one of the two or more images based on the detected orientation.

11. An electronic device, comprising:
two or more displays;
a storage configured to store one or more contents to be displayed in a pseudo 3D visualization;
an image generating unit configured to generate two or more images from one of the one or more contents stored in the storage; and
an image displaying unit configured to respectively display each of the two or more images on each of the two or more displays to show the content in the pseudo 3D visualization.

12. The electronic device of claim 11, wherein a first image of the two or more images corresponds to a front view of the content and the front view is displayed on a first display of the two or more displays, and
a second image of the two or more images corresponds to a rear view of the content and the rear view is displayed on a second display of the two or more displays.

13. The electronic device of claim 11, further comprising:
an image modifying unit configured to modify at least one of the two or more images when the electronic device is flipped; and
wherein the image displaying unit is further configured to display the at least one modified image on at least one of the tow or more displays.

14. The electronic device of claim 13, wherein the image modifying unit is further configured to modify a position and/or an appearance of at least one object of the two or more images based on a flipped direction of the electronic device.

15. The electronic device of claim 13, wherein the image modifying unit is further configured to modify an arrangement order of objects of the two or more images based on a flipped direction of the electronic device.

16. The electronic device of claim 13, further comprising:
a user interface unit configured to provide a user interface that allows a user to edit the at least one modified image.

17. The electronic device of claim 11, further comprising:
a detecting unit configured to detect an eye and/or a face of a user who faces one of the two or more displays; and
an image modifying unit configured to modify at least one of the two or more images based on the detected eye and/or the face.

18. The electronic device of claim 11, further comprising:
a detecting unit configured to detect an orientation of the electronic device; and
an image modifying unit configured to modify at least one of the two or more images based on the detected orientation.

19. A non-transitory computer-readable storage medium having stored thereon computer-executable instructions that, in response to execution, cause an electronic device to perform operations, comprising:
retrieving, from a storage, a content to be displayed in a pseudo 3D visualization;
generating two or more images from the content;
respectively displaying each of the two or more images on each of two or more displays to show the content in the pseudo 3D visualization; and
modifying at least one of the two or more images when the electronic device is flipped; and
displaying the at least one modified image on at least one of the two or more displays.

20. The non-transitory computer-readable storage medium of claim 19, wherein the modifying comprises:
modifying a position and/or an appearance of at least one object of the two or more images based on a flipped direction of the electronic device; and/or
modifying an arrangement order of objects of the two or more images based on the flipped direction of the electronic device.
